(19) United States
(12) Patent Application Publication
(10) Pub. No.: US 2025/0256794 A1
(43) Pub. Date: Aug. 14, 2025

(54) CENTER STAND SYSTEM

(71) Applicant: VINCE COSTA, ANAEHIM, CA (US)

(72) Inventor: VINCE COSTA, ANAEHIM, CA (US)

(21) Appl. No.: 19/039,226

(22) Filed: Jan. 28, 2025

Related U.S. Application Data
(60) Provisional application No. 63/553,323, filed on Feb. 14, 2024.

(51) Int. Cl. B62H 1/06; B62K 11/04; B62K 25/08

(52) U.S. Cl. CPC B62H 1/06; B62K 25/08; B62K 11/04

(57) ABSTRACT

A retractable motorcycle stand is attached to one or more of the frame members of a motorcycle and activated via a pneumatic actuator providing movement to the retractable motorcycle stand between an elevated position and a retracted position. The retractable motorcycle stand has a cross shaft pivotable held to the motorcycle frame with one or more stand legs connected to the cross shaft. The activator link is connected to a cross shaft, a pneumatic actuator is attached to the motorcycle frame and the pneumatic actuator also attaches to an activator link.

### FIELD OF THE INVENTION

The present invention is in the field of motorcycle stands.

### DISCUSSION OF RELATED ART

A variety of different center stand systems have been discussed in United States patents. For example, in U.S. Pat. No. 4,119,327 entitled “Lever for Motorcycle Center Stand” by Donald E. Emerson, published Oct. 10, 1978, the inventor describes, “A device for increasing the leverage on a motorcycle center stand to position it to support a motorcycle vertically. The center stand is pivotally secured to the motorcycle main frame and is formed of laterally spaced legs adapted to support the motorcycle on their lower ends in an at rest position. Upper end portions of the legs are pivotally mounted to the frame, the stand being normally spring biased on the pivot mounting in the upwardly non-functional position. A side arm on the stand extends outwardly of the motorcycle in the nonfunctional position and is adapted to move the stand downwardly against the force of the spring to a rearwardly vertical position and then past the pivot center to a forwardly-vertical position against the weight of the motorcycle to raise the motorcycle to a steady at rest position with the lower ends of the stand legs on the ground surface under the motorcycle. There is a foot pad on the side arm adjacent its outer end on which force is to be applied to move the arm and stand to the at rest position. The device is a lever securable to the arm adjacent its outer end and by which substantially additional force can be applied to the pad and the arm to move the stand past the pivot center to the at rest position.”

For example, in U.S. Pat. No. 4,582,336 issued Apr. 15, 1986, entitled “Center Stand for Motorcycle”, by Kunishige Onoda, the inventor describes, “This disclosure relates to a center stand for a motorcycle having a frame. The stand includes a support that is secured to and projects from the lower center part of the frame, supporting plates rotatably attached by first pivots to said support, second pivots on the supporting plates, and a main leg that is pivotably connected with said second pivots. In operation the center stand is erected by rotating the main leg around the second pivot to a generally vertical position and then rotating the supporting plates first around the first pivot until the main leg reaches the ground and then around the second pivot to lift the motorcycle onto the main leg.”

For example, in U.S. Pat. No. 5,118,126 issued Jun. 2, 1992, entitled “Powered Motorcycle Lift/Stand”, by Winfred E. Yaple, the inventor describes, “A hydraulically pneumatically, electrically, or engine operated motorcycle center stand assembly having ground-contacting lower stand unit rotatable about an axis on an upper stand unit. Parking is accomplished by rotation of said lower stand into said ground-contacting position, followed by downward pivoting of said upper stand unit, thereby raising said end of said motorcycle. The stand is raised by reversing the sequence. Ground contacting area, stand width, and stability are increased while simultaneously retaining maximum road clearance.”

For example, in U.S. Pat. No. 5,623,855 issued Apr. 29, 1997, entitled “Motorcycle Parking Stand”, by Vernon H. Miles, the inventor describes, “A center parking stand for a motorcycle which balances motorcycle without substantially bearing the weight of the motorcycle. The stand includes a mounting portion which mounts the stand to the motorcycle and allows the stand to rotate between Stowed and use positions. A pair of support legs extend away from the mounting portion and terminate in support surfaces adapted to engage a parking Surface. The legs have a length which enables the stand to be moved from its stowed position to its use position such that the rear wheel of the motorcycle remains engaged with the parking surface during the entire parking procedure and while the motorcycle is parked. The legs cooperate with one another and take over, from the rider, the function of balancing the motorcycle in its substantially vertical, non-leaning, position while the wheels of the motorcycle remain responsible for carrying the weight of the motorcycle. The stand additionally incorporates features that function to prevent the motorcycle from falling over in the event the stand penetrates into the parking surface. These features cooperate to bias the motorcycle to the left and support the motorcycle in a leaning position.”

For example, in United States publication number 2011/0024602 issued Feb. 3, 2011, entitled “Motorcycle Stand”, by Edward M. Lemus, the inventor describes, “A motorcycle stand includes first and second legs pivotable relative to one another between a maximum spread configuration, an intermediate spread configuration, and a storage configuration; the legs being generally parallel to one another when at the storage configuration. The motorcycle stand includes a biased plunger operatively coupled to the first leg and a pin operatively extending from at least one of the first and second legs. The second leg includes a first cavity configured to receive the plunger when the first and second legs are at the intermediate spread configuration. The first and second legs are maintained at the intermediate spread configuration when the plunger is received I the first cavity. The pin includes a distal segment for insertion in a motorcycle axle, the distal segment being neither parallel nor perpendicular to the first and second legs.”

For example, in United States publication number 2010/0013186 issued Jan. 21, 2010, entitled “Powered Retractable Motorcycle Stand”, by Alcide Markie, the inventor describes, “A fully powered motorcycle stand is disclosed that is attached to a motorcycle undercarriage and is able to extend legs on either side of the motorcycle. The legs are extended by a leg extending mechanism, such as an electric motor or a hydraulic pump and piston. Legs can include tubular and/or solid bars, and can have feet attached to the leg bottom. The legs can be connected, such as by a cross bar, or if not connected, can be separately extendable to different lengths so as to support the motorcycle vertically or uneven terrain. A stand controller send controls commands to the leg extending mechanism. A safety mechanism can be included that prevents leg extension while the motorcycle is moving, and an anti-theft system can be included that prevents leg retraction without a key or passcode.”

### SUMMARY OF THE INVENTION

A retractable motorcycle stand is attached to one or more of the frame members of a motorcycle and activated via a pneumatic actuator providing movement to the retractable motorcycle stand between an elevated position and a retracted position. The retractable motorcycle stand has a cross shaft pivotable held to the motorcycle frame with one or more stand legs connected to the cross shaft. The activator link is connected to a cross shaft, a pneumatic actuator is attached to the motorcycle frame and the pneumatic actuator also attaches to an activator link. When the pneumatic actuator is pressurized, the pneumatic actuator causes the activator link to move which in turn causes the cross shaft to rotate and the one or more stand legs to rotate from the up position to the down position. A spring is connected either directly or indirectly between the motorcycle frame and cross shaft causes the cross shaft to rotate and causes the stand legs to rotate to the up position when the vehicle is lifted with the actuator unpressurized. The weight of the bike keeps the stand in position even after loss of pressurization.

The activator link is slotted to allow smooth operation of the actuator. The vehicle is equipped with a device to change vehicle height, allowing the stand legs to move from the up position to the down position when the pneumatic actuator is energized. The pneumatic actuator consists of a cylindrical actuator cylinder body, wherein one end of the actuator cylinder body is closed off by an actuator cylinder end cap. An actuator piston resides inside the actuator cylinder body. The actuator pressurization chamber is created inside the actuator cylinder body between the actuator cylinder end cap and the Actuator Piston. The actuator shaft connects to the Actuator Piston at one end and the other end of the actuator shaft connects to the activator link. When the actuator pressurization chamber is pressurized via the cylinder inlet, the actuator Piston causes the Activator Link to rotate the cross shaft and cause the stand legs to rotate to the down position.

A pneumatic suspension system to raise the motorcycle to allow the retractable motorcycle stand to be easily cycled between the elevated position and the retracted position. The stand legs are curved to clear the motorcycle exhaust system. Further comprising a three-position pneumatic control unit, position one allows pressure to flow from the pneumatic actuator to exhaust. Position two allows pressure to flow from the suspension and the pneumatic actuator to the exhaust. Position three allows pressure to flow from the pressure supply to the suspension and the pneumatic actuator. Further comprising the three position pneumatic control unit to consist of an outer body with three ports, each port is connected to a central cylindrical opening and an adjuster rod placed inside the central cylindrical opening. The adjuster rod has a thick section and a thin section. When the thin section is near the opening created by the port it allows communication between ports next to the thin section and when the thick section is near the port it prevents communication between ports.

A pneumatic suspension system comprising a cylindrical inner tube coaxially placed inside a cylindrical outer tube, a dampener cartridge coaxially placed within the inner tube and outer tube. The dampener cartridge is comprised of a dampener body with an internal coaxial dampener rod and the dampener rod activates a piston inside the dampener body on one end and connects to a body cap on the other. The dampener rod slidably passes coaxially through an air piston and the air piston pushes either directly or indirectly on a mechanical coil spring. A compression chamber is formed between the air piston and body cap. The body cap has provision to provide high pressure air to said compression chamber.

The air piston slides inside the inner tube. A check valve is incorporated in the system so as to allow air to bleed back from the un-pressurized fork area to the compression chamber when the compression chamber pressure is reduced. The air piston slides inside an air chamber tube formed by a cylindrical tube inside the outer tube and wrapped around the dampener rod. The body cap connects to the outer tube and the air chamber tube, and a compression chamber is formed in the space bound by the body cap, the air chamber tube, and the air piston. A check valve allows high pressure trapped in the suspension system to pass into the compression chamber when the compression chamber pressure is reduced. A check valve is placed in the air piston which allows high pressure trapped in the suspension system to pass into the compression chamber when the compression chamber pressure is reduced. The check valve is placed in the body cap which allows high pressure trapped in the suspension system to pass into the compression chamber when the compression chamber pressure is reduced.

The pneumatic suspension system to raise the motorcycle comprises a cylindrical inner tube coaxially placed inside a cylindrical outer tube, a dampener cartridge coaxially placed within the inner tube and outer tube. The dampener cartridge is comprised of a dampener body with an internal coaxial dampener rod and the dampener rod activates a piston inside the dampener body on one end and connects to a body cap on the other. The dampener rod slidably passes coaxially through an air piston and air piston pushes either directly or indirectly on a mechanical coil spring. The compression chamber is formed between the air piston and body cap. The body cap has provision to provide high pressure air to the compression chamber.

### BRIEF DESCRIPTION OF THE DRAWINGS

FIG. 1 is a cross-section of the pneumatic suspension system.

FIG. 2 is a cross-section of the pneumatic suspension system.

FIG. 3 is a cross-section of the pneumatic suspension system.

FIG. 4 is a cross-section of the pneumatic suspension system.

FIG. 5 is a cross-section of the pneumatic suspension system.

FIG. 6 is a cross-section of the pneumatic suspension system.

FIG. 7 is a cross-section of the kickstand actuation system.

FIG. 8 is a diagram of the installation of the kickstand and pneumatic suspension system on the motorcycle.

The following call out list of elements can be useful guide to referencing the element numbers of the drawings.
20 Motorcycle
21 Vehicle Weight
22 Seat
23 Front Wheel
24 Rear Wheel
25 Lower Frame
26 Pneumatic suspension system
27 Kickstand Mechanism
30 Control Rod Assembly
31 Control Rod
32 Control Rod Opening
33 Forward Position
34 Rear Position
35 Control Rod Piston
36 First Control Rod Gasket
37 Second Control Rod Gasket
38 Third Control Rod Gasket
39 Fourth Control Rod Gasket
40 Air Connection
42 Second Air Connection
43 Third Air Connection
44 Air Inlet Tubing
45 Air Tubing Termination
46 Compressed Air Supply
50 Shaft Linkage
51 Shaft Linkage Slot
52 Shaft Linkage Carrier
53 Shaft Linkable Joint
61 Retainer Mount
62 Retainer Spring Mount
63 Retainer Spring Kickstand Mount
70 Piston
71 Kickstand Joint
72 Kickstand Foot
78 Kickstand
80 Frame
87 Air Line
88 Kickstand Piston Assembly
301 Inner Tube
302 Outer Tube
306 Cartridge System
313 Axel Clamp
320 Body Cap
321 Main Spring
337 Push Rod Tube
340 Spring Seat
351 Air Chamber
376 Body Cap Air Passage
392 Cartridge Shaft
401 Inner Tube
402 Outer Tube
413 Lower Leg
420 Body Cap
502 Kickstand Outer Tube
570 Kickstand Piston
587 Kickstand Airline
2089 Body Cap Check Valve
2702 Cartridge Body
7003 Piston Outer Seal
7004 Piston Inner Seal
7005 Cartridge Shaft Front End
7089 Piston Check Valve Assembly

### DETAILED DESCRIPTION OF THE PREFERRED EMBODIMENT

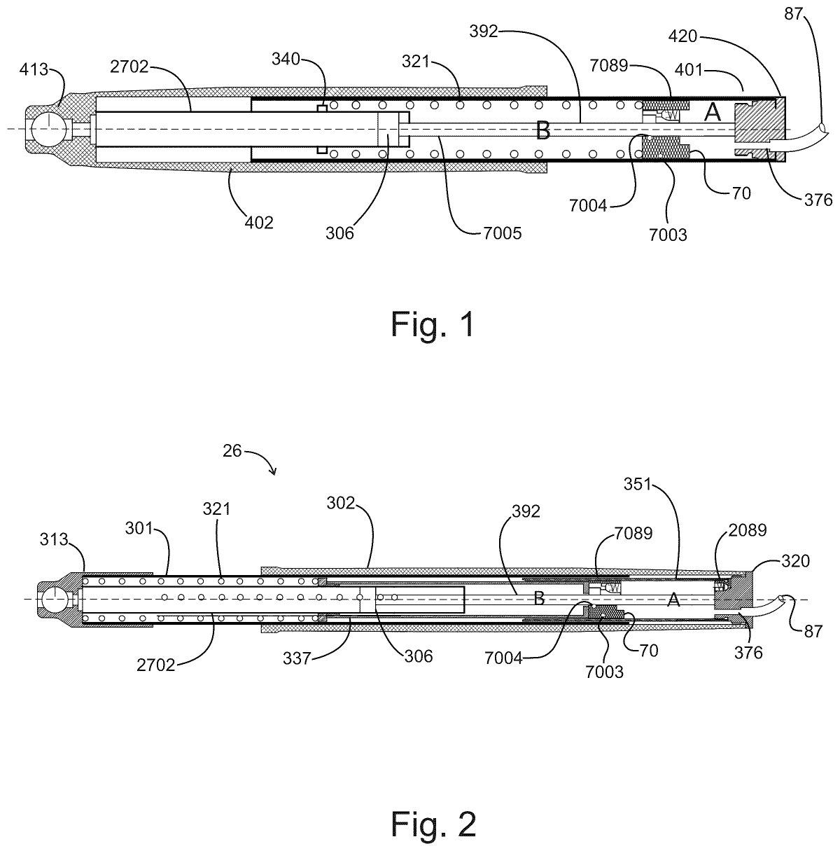

A pneumatic suspension system 26 for a vehicle such as a motorcycle can be mounted on the motorcycle front fork and be implemented as a pair of tubes mounted on the motorcycle fork tubes such as within the motorcycle fork tubes. Actuating the pneumatic lifter can raise and lower the vehicle between a raised position and a lowered position. The pneumatic lifter may raise the vehicle slightly to allow easier kickstand deployment. The kickstand can be a center stand that is mounted to the center of a frame of the motorcycle such as a lower portion of the frame of a motorcycle. As seen in FIG. 1, the pneumatic lifter of the pneumatic suspension system 26 has an outer tube 402 retains a piston 70, air line 87, cartridge system 306, main spring 321, spring seat 340, cartridge shaft 392, inner tube 401, lower leg 413, body cap 420, cartridge body 2702, piston outer seal 7003, piston inner seal 7004, and a piston check valve assembly 7089. The outer tube 402 retains the lower leg 413. The main spring 321 is mounted within the spring seat 340. The spring seat 340 is in turn mounted to the cartridge system 306. The cartridge system 306 has a cartridge body 2702. The cartridge body is mounted to the lower leg 41. The airline 87 connects at the body cap 420. The body 420 has an inner tube 401. The inner tube 401 slides within the outer tube 402. In this system, the inner tube 401 slides within the outer tube 402 and the inner tube has a cartridge system 306. The piston inner seal 7004 and the piston outer seal 7003 seal the cartridge shaft 392 to the inner tube 401. The airline 87 can add or subtract air to adjust force. The spring seat 340 works with the piston 72 sandwich and retain the spring. The spring rides around the cartridge body 2702.

As seen in FIG. 2, the pneumatic suspension system 26 is formed as an assembly which includes a piston 70, air line 87, inner tube 301, cartridge system 306, axle clamp 313, body cap 320, main spring 321, pushrod tube 337, air chamber 351, body cap air passage 376, body cap check valve 2089, cartridge body 2702, piston outer seal 7003, piston inner seal 7004, and a piston check valve assembly 7089. The inner tube 301 retracts telescopically into the outer tube 302. The cartridge system 306 is formed as a tube that receives a cartridge shaft 392. The cartridge shaft 392 reciprocates into and out of the cartridge 306. The cartridge body 2702 can receive a pressurization. The axle clamp 313 connects to the inner tube 301. The main spring 321 is mounted between the inner tube 301 and the cartridge body 2702. The pushrod tube 337 mounts over the cartridge body 270 to and compresses the main spring 321. Thus, the pushrod tube 337 reciprocally moves relative to the cartridge body 2702. The air chamber 351 fits around the end of the pushrod tube 337. The air chamber has a piston 70 that has a gasket including a piston outer seal 7003 and a piston inner seal 7004. The piston check valve assembly 7089 can act as a valve for admitting or releasing air in a controlled manner. The body check valve 2089 can also admit or release air in a controlled fashion. Air can be pumped in at the airline 87. The airline 87 can reinflate the air chamber and 351. Thus, the stand has a spring suspension while also having an air suspension which actuates and deactuates the system between a stowed position and a deployed position.

The pneumatic actuator deploys the stand legs and the weight of the motorcycle retains the stand legs in deployed position. The pneumatic actuator has valves that controls the system to operate between the stowed position and the deployed position. The pneumatic actuator has a spring suspension in both the deployed position and the stowed position.

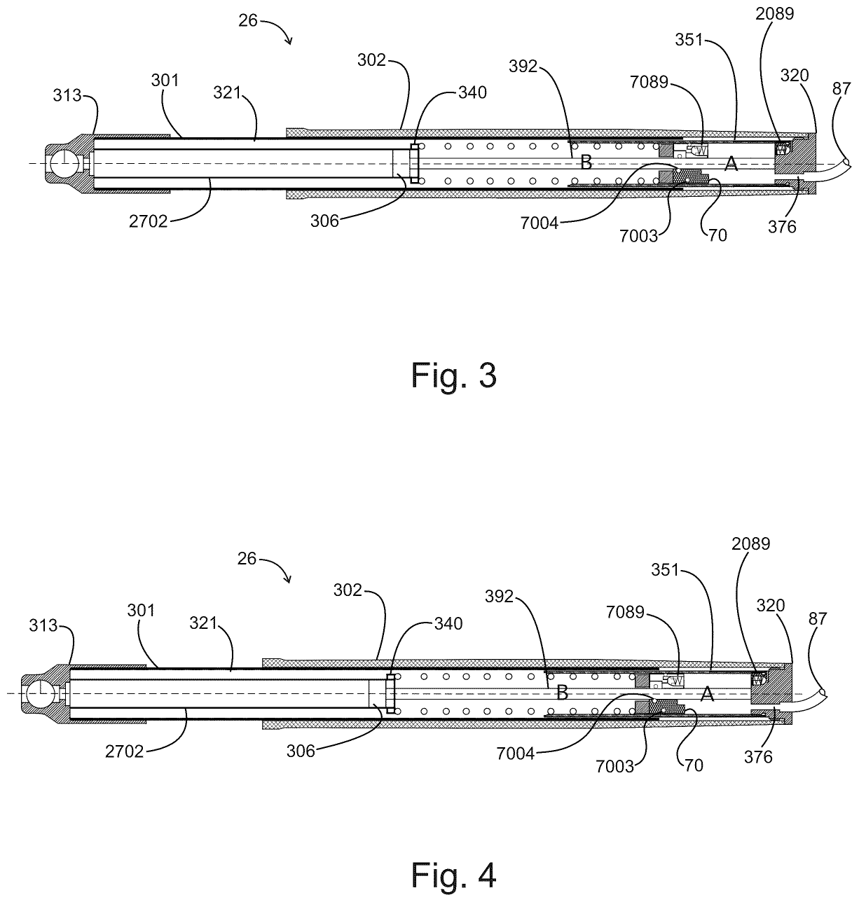

As seen in FIG. 3, the piston assembly of the pneumatic suspension system 26 has a piston 70, air line 87, inner tube 301, outer tube 302, cartridge system 306, axle clamp 313, body cap 320, main spring 321, air chamber 351, body cap air passage 376, cartridge shaft 392, body cap check valve 2089, cartridge body 2702, piston outer seal 7003, piston inner seal 7004, and a piston check valve assembly 7089. The piston 70 moves when the airline 87 receives air. The piston slides depending upon the operation of the body check valve 2089 and the piston check valve assembly 7089 which in combination can admit and release air. The air chamber 351 thus slides relative to the inner tube 301. The main spring 321 presses against the piston 70. The main spring 321 compresses when the motorcycle stand is in deployed position and the stand is pressing against the ground to support the motorcycle. The spring loaded deployed position may have the main spring mounted to the end of the cartridge body 2702. The body cap air passage 376 receives air from the airline 87 and introduces air into the air chamber 351. The body cap air passage 376 passes through the body cap 3020. The body cap 320 is mounted to the air chamber 351 and the outer tube 302. The air chamber 351 is formed as a small tube that has a smaller diameter than the outer tube 302. The air chamber 351 fits inside the outer tube 302. The air chamber 351 moves with the outer tube 302. The inner tube 301 moves between the outer tube 302 and the air chamber 351.

The cartridge body 2702 fits within the inner tube 301 and the cartridge body 2702 has a tubular profile that fits within the inner tube 301. The inner tube 301 fits to the axle clamp 313. The axle clamp 313 forms a socket for receiving the inner tube 301. The inner tube 301 has a telescopic connection with the outer tube 302. The inner tube 301 slides within the outer tube 302. The inner tube 301 also slides relative to the air chamber 351. In this alternate embodiment, the main spring is mounted to fit between the cartridge system 306 and the piston 70.

As seen in FIG. 4, the piston assembly of the pneumatic suspension system 26 has a piston 70, air line 87, inner tube 301, outer tube 302, cartridge system 306, axle clamp 313, body cap 320, main spring 321, air chamber 351, body cap air passage 376, cartridge shaft 392, body cap check valve 2089, cartridge body 2702, piston outer seal 7003, piston inner seal 7004, and a piston check valve assembly 708. FIG. 4 shows an alternate embodiment where the main spring is not backed by a main spring gasket receiver. Instead, the main spring fits against the piston 70. The piston check valve assembly 7089 can admit air and cooperate with the inner tube air chamber in the inner tube 301.

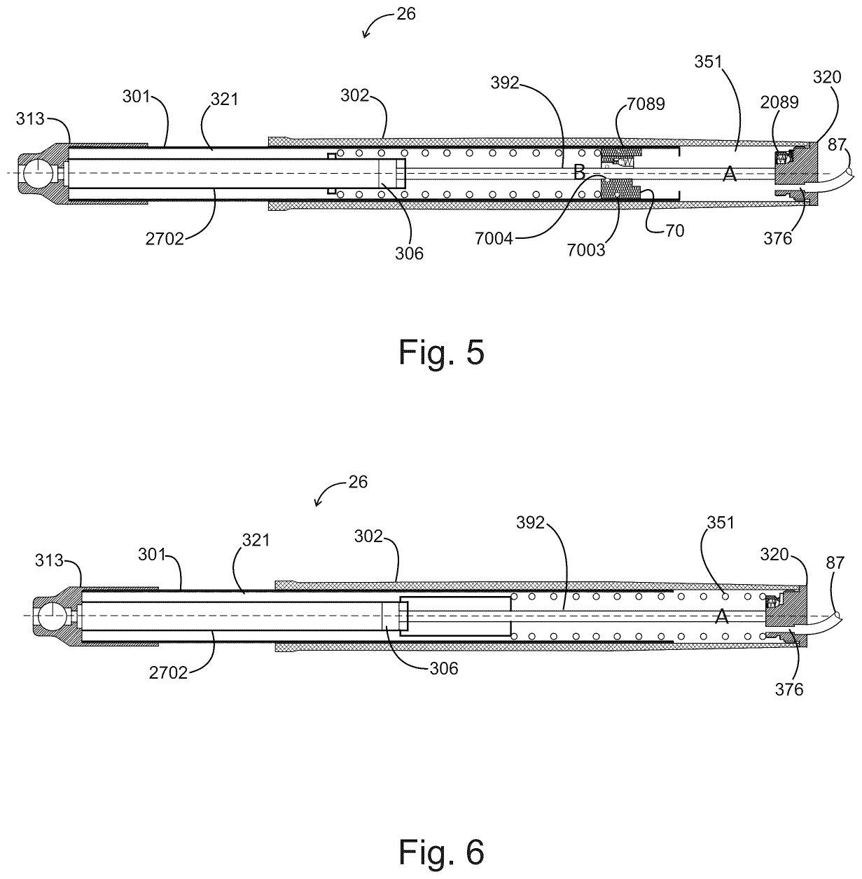

As seen in FIG. 5, the piston assembly of the pneumatic suspension system 26 has a piston 70, air line 87, inner tube 301, outer tube 302, cartridge system 306, axle clamp 313, body cap 320, main spring 321, air chamber 351, body cap air passage 376, cartridge shaft 392, body cap check valve 2089, cartridge body 2702, piston outer seal 7003, piston inner seal 7004, and a piston check valve assembly 7089. The piston 70 passes from the body cap 320 to the piston 70 to the cartridge system 306. The inner tube 301 fits telescopically in the outer tube 302. The cartridge system 306 fits in the inner tube 301. The cartridge system 306 and the inner tube 301 are mounted to the axle clamp 313.

The outer tube 30 and the cartridge shaft 392 are mounted to the body cap 320. The air chamber 351 is formed between the body cap 320 and the piston 70. The piston 70 has a piston outer seal 7003 and a piston inner seal 7004. The piston check valve assembly 7089 is mounted to the inner tube 301 at a right side of the inner tube 301. The piston 70 presses against the main spring on the right side. The main spring compresses against the cartridge body 2702 and the cartridge body can have an annular extension that sandwiches the main spring on the left side. The main spring can then fit between the cartridge body 2702 and the inner tube 301.

As seen in FIG. 6 the piston assembly of the pneumatic suspension system 26 has a piston 70, inner tube 301, outer tube 302, cartridge system 306, axle clamp 313, body cap 320, main spring 321, air chamber 351, cartridge shaft 392, and the cartridge body 2702. In this embodiment, the air chamber 351 receives the main spring. Again, the outer tube 30 and the cartridge shaft 392 are mounted to the body cap 320, while the cartridge system 306 and the inner tube 301 are mounted to the axle clamp 313. The cartridge system 306 has an extension that compresses against the main spring. The control valve which can be either the piston check valve assembly 7089 or the body cap check valve 2089 can be mounted to the body cap 320 for controlling air pressure in the outer tube 302. The outer tube 302 is in telescopic sliding mounting with the inner tube 301. The main spring fits within the inner tube 301. The main spring abuts against the cartridge system 306 at a cartridge system extension.

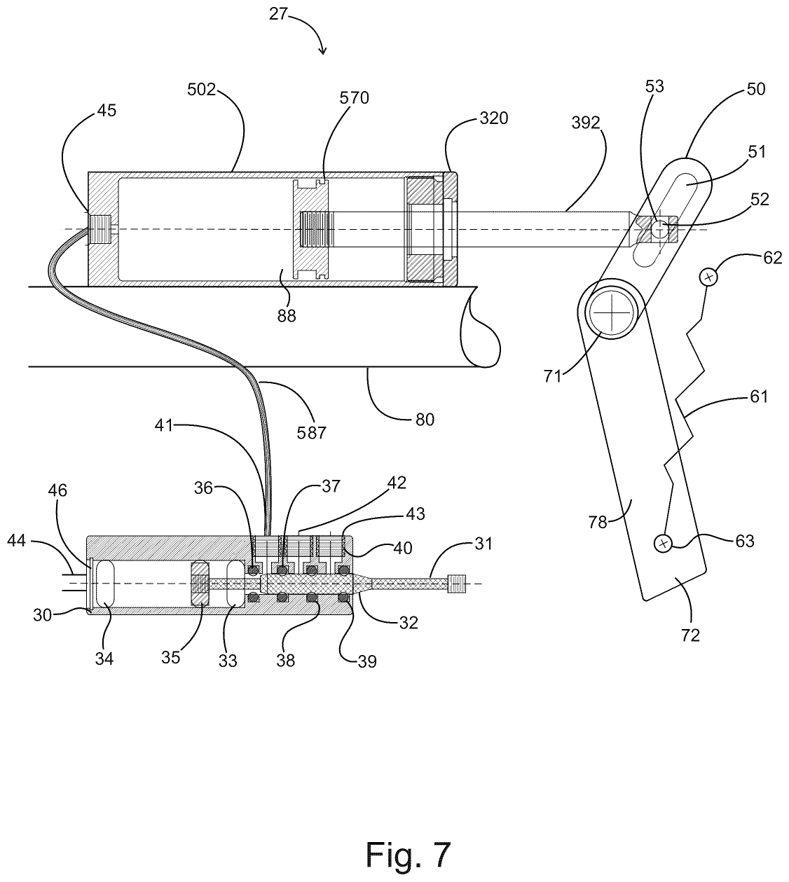

As seen in FIG. 7, a diagram of the kickstand mechanism 27 shows installation of the kickstand piston assembly 88. The kickstand mechanism 27 is assisted by the pneumatic suspension system 26. The kickstand piston assembly 88 of the kickstand mechanism 27 is preferably mounted to a frame 80. The kickstand piston assembly 88 receives an air tubing termination 45 which pressurizes a kickstand outer tube 502. The kickstand piston 570 slides within the outer tube 502. The cartridge shaft 392 extends from the body cap 320. The air tubing 44 can be formed as an air line 87. The air tubing 44 connects to a first air connection 41. Other air tubes can be connected to a second air connection 42 and a third air connection 43. The air connections 40 are formed on the control rod assembly 30. The control rod piston 35 has a forward position 33 and the rear position 34. The control rod 31 successively actuates three of the valves allowing air to the first air connection 41, the second air connection 42, then the third air connection 43. The control rod 31 is mounted within a control rod opening 32. The control rod opening 32 is formed within the control rod assembly 30. The control rod opening 32 has a first control rod gasket 36, a second control rod gasket 37, a third control rod gasket 38, and a fourth control rod gasket 39. The successive control rod gasket control air flow through the first air connection 41, then the second air connection 42, then the third air connection 43 depending upon the position of the control rod piston 35.

The cartridge shaft 392 connects to a shaft linkage 50 at a shaft linkage slot 51. The shaft linkage slot receives the cartridge shaft 392 at a shaft linkage joint 53. The shaft linkage carrier 52 rides within the shaft linkage slot 51. The shaft linkage carrier 52 cooperates with the shaft linkage slot 51 to form the shaft linkage joint 53. The shaft linkage carrier 52 is mounted to an end of the cartridge shaft 392. The kickstand 78 connects to the shaft linkage 50 at a kickstand joint 71. The kickstand joint 71 can be ratcheted or directly rigidly connected. The kickstand 78 is biased to an engaged deployed position from a stowed position with a retainer spring 61. The retainer spring 61 is mounted to the frame 80 at a retainer spring mount 62. The retainer spring 61 is also mounted to the kickstand 78 at the retainer spring kickstand mount 63. The kickstand 78 has a kickstand foot 72 for bearing on a ground.

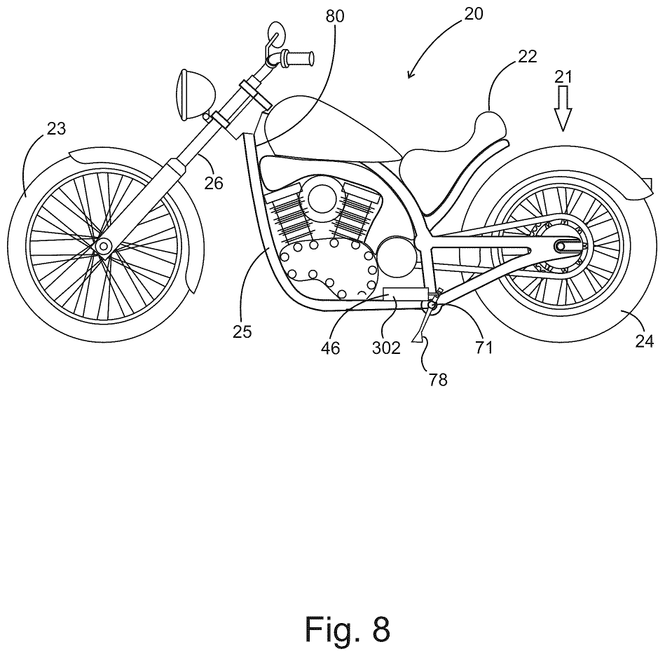

As seen in FIG. 8, the motorcycle 20 has a front wheel 23 and a rear wheel 24. The vehicle weight 21 depresses the kickstand 78 in engaged position. The kickstand joint 71 is connected to the kickstand 78 and is actuated by the actuator. The actuator is mounted in the outer tube 302 which is mounted to the lower frame 25 of the frame 80. The compressed air supply 46 can be adjacent to the outer tube 302 or can be connected by a line to be actuated remotely. The pneumatic suspension system 26 can be connected and synchronized to the kickstand actuation mechanism so that the vehicle rises during kickstand actuation so that the total amount of force required to actuate the kickstand is decreased during the actuation of the pneumatic suspension system which raises the height of the vehicle. The entire system can be triggered manually such as with a button. When a user gets off the bike, the user can push a button to activate the automatic kickstand engagement. The center stand system enables kickstand engagement for heavy bikes and motorcycle enthusiasts that may be physically disabled such as from a past injury. The system may include the kickstand mechanism 27 by itself or the pneumatic suspension system 26 by itself or the pneumatic suspension system 26 or the kickstand mechanism 27 in conjunction.

1. A retractable motorcycle stand, wherein the retractable motorcycle stand is configured to attach to a motorcycle frame and comprises:
a pneumatic actuator, wherein the pneumatic actuator moves the retractable motorcycle stand between an elevated position and a retracted position, wherein the pneumatic actuator is attached to the motorcycle frame;
a cross shaft pivotably mounted to the motorcycle frame;
a stand leg connected to the cross shaft; and
an activator link connected to the cross shaft, wherein the pneumatic actuator is attached to the activator link, wherein the pneumatic actuator configured to have a pressurized mode and an unpressurized mode, wherein the pneumatic actuator moves the activator link between the pressurized mode and the unpressurized mode which rotates the cross shaft and the one or more stand legs from a retracted position to a deployed position.

2. The retractable motorcycle stand of claim 1, further including a spring connected either directly or indirectly between the motorcycle frame and the cross shaft; wherein the spring rotates the cross shaft and rotates the stand legs to the retracted position when a vehicle is lifted with the actuator unpressurized, wherein vehicle weight keeps the stand in position even after loss of pressurization.

3. The retractable motorcycle stand of claim 1, wherein the activator link is slotted with an activator link slot, whereby allowing smooth operation of the actuator.

4. The retractable motorcycle stand of claim 1, wherein the retractable motorcycle stand is coordinated with a vehicle height adjustment device, wherein as the stand leg moves from retracted position which is an up position to a deployed position which is a down position when the pneumatic actuator is activated, the vehicle increases in height when the stand leg depresses the ground in the deployed position.

5. The retractable motorcycle stand of claim 1, wherein the pneumatic actuator comprises a cylindrical actuator cylinder body, wherein one end of the actuator cylinder body is closed off by an actuator cylinder end cap, wherein an actuator piston resides inside the actuator cylinder body; wherein an actuator pressurization chamber is created inside the actuator cylinder body between the actuator cylinder end cap and the actuator piston; wherein an actuator shaft connects the actuator piston at one end and the other end of the actuator shaft to the activator link; wherein the actuator pressurization chamber is pressurized via the cylinder inlet to the actuator piston to move the activator link to rotate the cross shaft and rotate the stand legs to the deployed position.

6. The retractable motorcycle stand of claim 1, further including a pneumatic suspension system which raises the motorcycle so as to allow the retractable motorcycle stand to be easily cycled between the elevated position and the retracted position wherein the pneumatic suspension system has a raised position and a lowered position, wherein the pneumatic suspension system raises the motorcycles to the raised position as the retractable motorcycle stand is being lowered to a deployed position.

7. The retractable motorcycle stand of claim 1, wherein the stand leg is curved so as to clear the motorcycle exhaust system.

8. The retractable motorcycle stand of claim 1, further comprising: a three-position pneumatic control unit, wherein the three position pneumatic control unit includes three positions namely: a first position, wherein the first position allows pressure to flow from the pneumatic actuator to exhaust; a second position, wherein the second position allows pressure to flow from the suspension and the pneumatic actuator to the exhaust; and a third position, wherein the third position allows pressure to flow from the pressure supply to the suspension and the pneumatic actuator.

9. The retractable motorcycle stand of claim 8, wherein the three position pneumatic control unit includes an outer body with three ports, wherein each port is connected to a central cylindrical opening and an adjuster rod is placed inside the central cylindrical opening, wherein the adjuster rod has a thick section and a thin section; wherein when the thin section moves towards a port opening, the thin section allows communication between ports next to the thin section and when the thick section moves towards the port the thick section blocks communication between ports.

10. A pneumatic suspension system comprising:
a. a cylindrical inner tube coaxially placed inside a cylindrical outer tube;
b. a dampener cartridge coaxially placed within the inner tube and outer tube, wherein the dampener cartridge has a dampener body with an internal coaxial dampener rod, wherein the dampener rod activates a piston inside the dampener body on one end and connects to a body cap on the other;
c. an air piston, wherein the dampener rod slidably passes coaxially through the air piston, wherein the air piston pushes either directly or indirectly on a mechanical coil spring; and
d. a compression chamber, wherein the compression chamber is formed between the air piston and the body cap, wherein the body cap has provision to provide high pressure air to the compression chamber.

11. The pneumatic suspension system of claim 10, wherein the air piston slides inside the inner tube.

12. The pneumatic suspension system of claim 10, further including a check valve configured to allow air to bleed back from the un-pressurized fork area to the compression chamber when the compression chamber pressure is reduced.

13. The pneumatic suspension system of claim 10, further including an air chamber tube, wherein the air piston slides inside the air chamber tube formed by a cylindrical tube inside the outer tube and wrapped around the dampener rod; wherein the body cap connects to the outer tube and the air chamber tube; further including a compression chamber, wherein the compression chamber is formed in the space bound by the body cap, the air chamber tube and the air piston.

14. The pneumatic suspension system of claim 13, further including a check valve, wherein the check valve is configured to pass high pressure trapped in the suspension system into the compression chamber when the compression chamber pressure is reduced.

15. The pneumatic suspension system of claim 13, further including a check valve, wherein the check valve is placed in the air piston and configured to pass high pressure trapped in the suspension system into the compression chamber when the compression chamber pressure is reduced.

16. The pneumatic suspension system of claim 13, further including a check valve, wherein the check valve is placed in the body cap and configured to pass high pressure trapped in the suspension system into the compression chamber when the compression chamber pressure is reduced.

17. The pneumatic suspension system of claim 16, wherein the pneumatic suspension system to raise the motorcycle further includes a cylindrical inner tube coaxially placed inside a cylindrical outer tube, and a dampener cartridge coaxially placed within the inner tube and outer tube; the dampener cartridge is comprised of a dampener body with an internal coaxial dampener rod, wherein the dampener rod activates a piston inside the dampener body on one end and connects to a body cap on the other, wherein the dampener rod slidably passes coaxially through an air piston, wherein the air piston pushes either directly or indirectly on a mechanical coil spring, wherein a compression chamber is formed between the air piston and the body cap, wherein the body cap has provision to provide high pressure air to the compression chamber.

18. The pneumatic suspension system of claim 10, further including a retractable motorcycle stand, wherein the retractable motorcycle stand is configured to attach to a motorcycle frame and comprises:
a pneumatic actuator, wherein the pneumatic actuator moves the retractable motorcycle stand between an elevated position and a retracted position, wherein the pneumatic actuator is attached to the motorcycle frame;
a cross shaft pivotably mounted to the motorcycle frame;
a stand leg connected to the cross shaft; and
an activator link connected to the cross shaft, wherein the pneumatic actuator is attached to the activator link, wherein the pneumatic actuator configured to have a pressurized mode and an unpressurized mode, wherein the pneumatic actuator moves the activator link between the pressurized mode and the unpressurized mode which rotates the cross shaft and the one or more stand legs from a retracted position to a deployed position.
